(19) United States
(12) Patent Application Publication
(10) Pub. No.: US 2026/0099691 A1
(43) Pub. Date: Apr. 9, 2026

(54) Systems and Methods for Radiofrequency Tag Locking

(71) Applicant: Zebra Technologies Corporation, Lincolnshire, IL (US)

(72) Inventors: Christopher Aiello, Franklin Park, IL (US); Michael K. Fein, Lake Bluff, IL (US); Chris H. Robertson, Oark, AR (US); Blake E. Nemura, Saint Charles, IL (US)

(73) Assignee: Zebra Technologies Corporation, Lincolnshire, IL (US)

(21) Appl. No.: 19/010,626

(22) Filed: Jan. 6, 2025

Related U.S. Application Data
(60) Provisional application No. 63/703,024, filed on Oct. 3, 2024.

(51) Int. Cl. G06K 19/073; G06K 7/10; G06K 19/07

(52) U.S. Cl. CPC G06K 19/07309; G06K 7/10009; G06K 19/0723

(57) ABSTRACT

A method in a media processing device, the method comprising: obtaining a set of parameters corresponding to a radiofrequency (RF) tag associated with a media supply; receiving a first command to lock the radiofrequency (RF) tag; generating a second command, the second command including the set of parameters; and initiating an operation to lock the RF tag based on the second command.

### RELATED APPLICATIONS

The present application claims priority to and the benefit of U.S. Provisional Application No. 63/703,024, filed on Oct. 3, 2024, which is incorporated by reference herein in its entirety.

### BACKGROUND

Radiofrequency (RF) tags can be used to store a wide variety of data, such as product identifiers and the like. RF tags may include a number of memory banks, and may implement functionality to lock the memory banks in response to lock commands. The variable nature of such functionality in different types of RF tags may lead to lock commands failing.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a media processing device.

FIG. 2 is a cross section of the media processing device of FIG. 1.

FIG. 3 is a flowchart of a method for radiofrequency tag locking.

FIG. 4 is a diagram illustrating an example performance of blocks 310, 312, 315, and 320 of the method of FIG. 3.

FIG. 5 is a diagram illustrating an example performance of block 340 of the method of FIG. 3.

FIG. 6 is a flowchart of an additional portion of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Examples disclosed herein are directed to a method in a media processing device, the method comprising: obtaining a set of parameters corresponding to a radiofrequency (RF) tag associated with a media supply; receiving a first command to lock the radiofrequency (RF) tag; generating a second command, the second command including the set of parameters; and initiating an operation to lock the RF tag based on the second command.

Additional examples disclosed herein are directed to a device, comprising: a housing; a printhead disposed in the housing, the printhead being configured to print on a media supply; a radiofrequency (RF) transcoder (e.g., encoder/reader) disposed in the housing; and a controller configured to: obtain a set of parameters corresponding to a radiofrequency (RF) tag associated with a media supply; receive a first command to lock the radiofrequency (RF) tag; generate a second command, the second command including the set of parameters; and initiate an operation to lock the RF tag based on the second command.

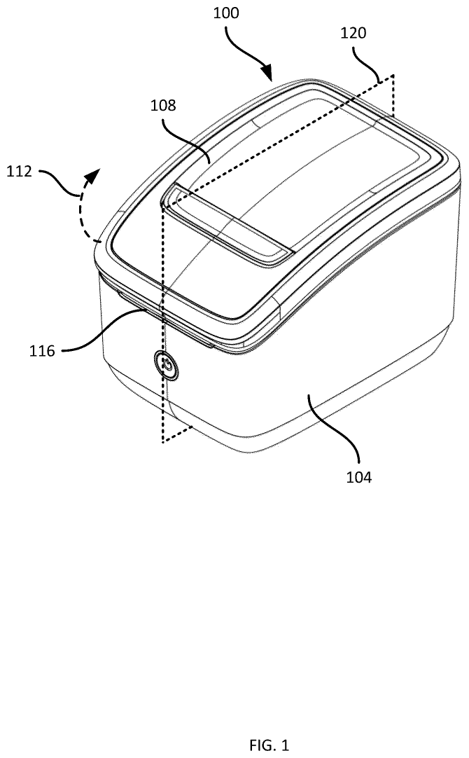

FIG. 1 illustrates an example device in the form of a media processing device 100, such as a label printer (also referred to herein as the printer 100). The printer 100 can be implemented as a desktop printer, as illustrated. The printer 100 can also be implemented in a wide variety of other form factors, including a mobile printer, tabletop or industrial printer, or the like. The printer 100 includes various components configured to apply indicia to media such as discrete labels, a continuous paper strip, identity cards, or the like. The indicia can be applied, for example, by direct thermal printing, thermal transfer printing, or the like. In other examples, the media processing device 100 can include a radio frequency (RF) transcoder (e.g., encoder/reader) assembly configured to read data from RF tags embedded in the labels, write data to RF tags embedded in labels or other media, in addition to or instead of applying indicia to the media.

The printer 100 includes a body 104 housing a media supply, a printhead, and other components, as well as a cover or door 108 configured to open (e.g., in a direction 112) to provide access to an interior of the printer 100. The printer 100 further includes an outlet 116, from which processed media (e.g., labels with indicia having been applied thereto within the body 104 of the printer 100) is dispensed.

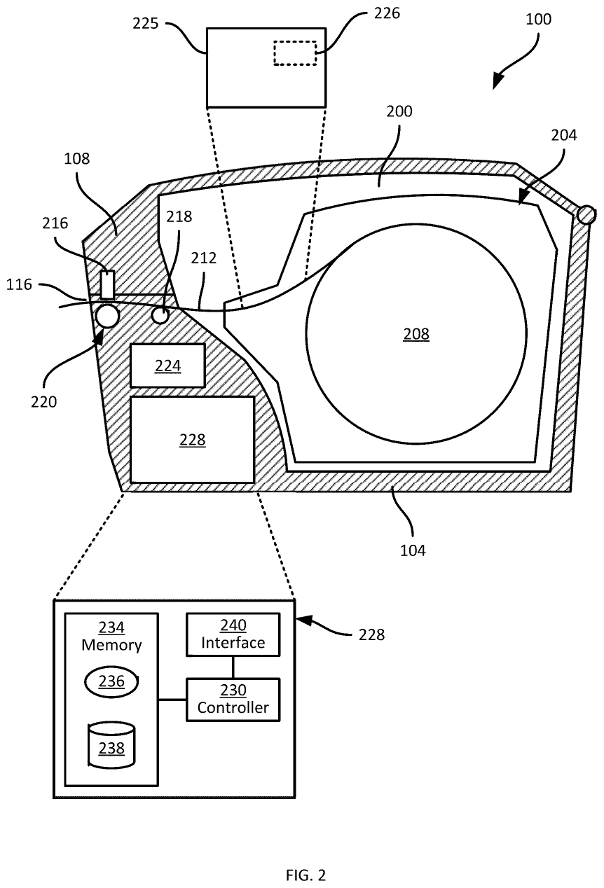

FIG. 2 illustrates a simplified cross sectional view of the printer 100, taken at the plane 120 shown in FIG. 1. As seen in FIG. 2, the body 104 and the cover 108 define a chamber 200 for receiving one or more media supplies, such as a roll 208 of paper, labels, or the like, a media cartridge 204 (also referred to herein as a supply 204) containing a roll 208 of paper, labels, or the like, or other media supplies. In other examples, the media supplies accommodated in the chamber 200 can include boxes of fan-feed labels, identity cards, or the like. In still other examples, the printer 100 can include an inlet in the body 104 for receiving media from an external supply, e.g., to travel through the chamber 200 for processing.

Media 212 from the supply 204 (e.g., from the roll 208, in the illustrated example) travels along a media path from the supply 204 to a nip formed by a printhead 216 and a platen roller 220. The media path can be defined by surfaces, rollers, and the like, such as a guide roller 218 (e.g., a passive, or non-driven, roller). The platen roller 220 can be driven, e.g., to pull the media 212 along the media path and through the nip, where the printhead 216 applies indicia to the media 212. The processed media (e.g., bearing indicia applied by the printhead 216) is then dispensed at the outlet 116. The device 100 also includes an RF transcoder 224, e.g., including one or more antennas and associated controllers, configured to read data from and/or write data to RF tags embedded in the media. For example, the supply 204 can be a roll of labels, an example label 225 of which is shown in FIG. 2 in overhead view, with an embedded RF tag 226.

In some examples, the printhead 216 can be omitted and the device 100 can be configured as an RF reading and/or writing device, e.g., including the RF transcoder 224 and omitting pigment-based printing functionality.

The device 100 further includes a control subsystem 228. As shown in FIG. 2, the control subsystem 228 can include a controller 230 such as a central processing unit (CPU), an application-specific integrated circuit (ASIC), or the like, connected to and/or integrated with a memory 234 storing a plurality of computer-executable instructions. The instructions can include, for example, a control application 236, e.g., implemented as firmware or the like. The memory 234 can also store one or more repositories, such as lookup tables or the like. In this example, the memory 234 stores a repository 238 of RF tag attributes. The repository 238 can be a structured file, e.g., based on an extensible markup language (XML) schema or the like.

The subsystem 228 can also include a communication interface 240, e.g., including one or more antennas and/or data ports and associated control hardware permitting the device 100 to communicate with other computing devices. For example, the device 100 can receive media processing commands from a host computing device (e.g., a desktop computer, a smartphone, server, or the like), including data such as text, images, or the like, to be printed onto media from the supply 204 (e.g., onto a given label). The device 100 can also receive data to be written to an RF tag embedded in the media. For example, the command can include an electronic product identifier (EPC) to be written to the RF tag 226 of a given label 225.

To execute a media processing command, the controller 230 can control the printhead 216 to apply indicia to the media 212, e.g., by activating thermal elements of the printhead 216 to apply heat to corresponding portions of the media 212. As will be apparent to those skilled in the art, for direct thermal printers, as shown in FIG. 2, application of heat to a portion of the media 212 may activate a thermochromic pigment in the media 212. For thermal transfer printers, a pigment-carrying ribbon (not shown) can traverse the nip with the media 212, and application of heat to a portion of the media 212 and the ribbon can cause the transfer of pigment from the ribbon to the media 212.

The controller 230 can further control the RF transcoder 224 to read data from the RF tag 226 and/or write data from a media processing command to the RF tag 226. For example, the controller 230 can be configured to operate the RF transcoder 224 to read data stored in a tag identifier (TID) memory bank of the RF tag 226. The TID data can include a model number of the RF tag 226 (e.g., which may be the same for each RF tag 226 in the roll 208), a serial number corresponding to the tag RF 226, or the like.

The controller 230 can further be configured to operate the RF transcoder 224 to write data included in the above-mentioned command to a memory of the RF tag 226. A wide variety of data can be written to the RF tag 226, including for example an electronic product code (EPC) or other item identifier. The RF tag 226 can include an EPC memory bank to which such information can be written. In some deployments, it may be desirable to lock the contents of one or more memory banks of the RF tag 226, e.g., to prevent tampering or inadvertent overwriting of data. The RF tag 226 may be configured to place each memory bank in one of a plurality of predefined access states. For example, a given memory bank may be locked such that it cannot be written to unless unlocked (e.g., with an access password). The memory bank may also be permanently locked (also referred to as perma-locked), such that it can no longer be written to under any circumstances. Memory banks can also be unlocked (and therefore writable), and perma-unlocked (e.g., writable, and unable to be locked) in some examples.

Locking or perma-locking an RF tag 226 involves executing, for example, a lock command via the RF transcoder 224. Although RF tags 226 of various types (e.g., various models of RF tag from various manufacturers) may support locked and perma-locked states, locking or perma-locking different types of RF tags 226 may involve the use of different lock or perma-lock commands. For example, a lock or perma-lock command may include a plurality of parameters, (independently) identifying which memory banks are to be locked. When multiple types of RF tags are to be used by the device 100, locking errors can occur if the operator does not include all the parameters corresponding to the banks to be locked. As an example, the operator may intend to issue a perma-lock command to perma-lock all memory banks in the RF tag 226. However, if the operator omits a parameter for perma-locking one of the memory banks, the memory bank corresponding to the omitted parameter is not locked and the operator will not be aware that the memory bank is not locked (without attempting to write to the memory bank). Additionally, some RF tags 226, may omit some memory banks (e.g., an auxiliary or “user” memory bank) that are included in other RF tags. Other RF tags 226 may not support certain locking parameters, such as a parameter identifying the TID memory bank. If a lock command identifying the TID bank or an omitted memory bank is executed on such an RF tag 226, the command may fail (e.g., result in the RF tag 226 remaining unlocked and/or generate an error).

The lock or perma-lock commands mentioned above may be received at the device 100 from a host application executed by another computing device, in some examples. In such implementations, the host application may be responsible for providing a correctly-formatted lock or perma-lock command to the device 100. The breadth of host applications and the entities that develop and maintain such applications, as well as the variety of RF tags 226 available, can lead to malformed lock or perma-lock commands and thus to failed or inadequate locking operations.

As discussed below, the device 100 is configured to implement tag-locking functionality permitting the device 100 to receive a generic or universal command, for example to perma-lock an RF tag 226 (although this functionality may also be used for locking, in addition to or instead of perma-locking). The command received by the device 100 may be referred to as generic or universal because the same command can be used for a plurality of types of RF tag 226, with heterogeneous perma-lock command formats. The device 100 is further configured, based on the generic or universal command and on a set of parameters specific to the RF tag 226, e.g., obtained from the repository 238 or based on certain properties read from the RF tag 226, to generate a specific perma-lock command to apply to the particular RF tag 226 to be locked.

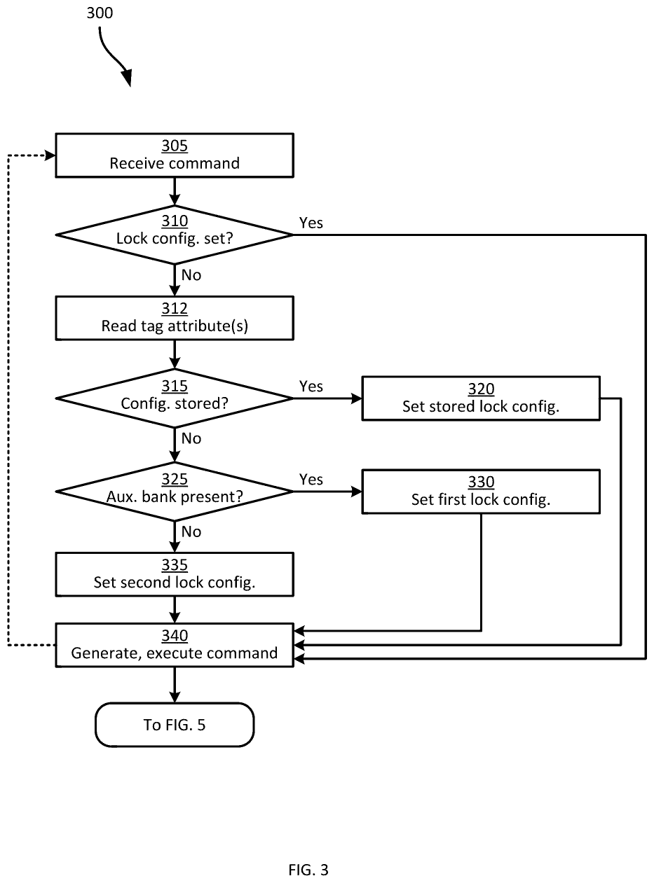

Turning to FIG. 3, a method 300 of locking or perma-locking RF tags is illustrated. The method 300 will be described in conjunction with its performance in the device 100, and in particular by the controller 230, via execution of the application 236. The discussion below refers to commands for perma-locking the RF tag 226, but it will be understood that the functionality set out below may also be used for applying other state changes to the RF tag 226, including locking (e.g., non-permanent locking).

At block 305, the device 100 is configured to receive a command, e.g., from another computing device in communication with the device 100. The command can be referred to as a media processing command, and may include a command to read data from the RF tag 226, such as TID data. The command can include, in other examples, data to be written to the RF tag 226 and/or data to be printed to the label 225. The command can also include, in some examples, a perma-lock command configured to permanently lock the memory banks of the RF tag 226.

At block 310, the device 100 is configured to determine whether lock configuration data has been set at the device 100. For example, the device 100 can maintain current lock configuration data that defines a set of memory banks to be identified in perma-lock commands applied to the RF tag 226. The lock configuration data can be stored in a buffer, register, or the like, of the device 100, and can be reset (e.g., discarded) when the device 100 powers on, the cover 108 closes, or the like. In other words, the device 100 can be configured to discard or otherwise reset the lock configuration data in response to any event that may correspond with the installation of a new media supply 204 in the device 100.

When the determination at block 310 is affirmative, indicating that current lock configuration data exists, the device 100 can proceed to execute the command from block 305. In other words, an affirmative determination at block 310 indicates that a previous performance of the method 300 has resulted in the storage of current lock configuration data for the current media supply 204.

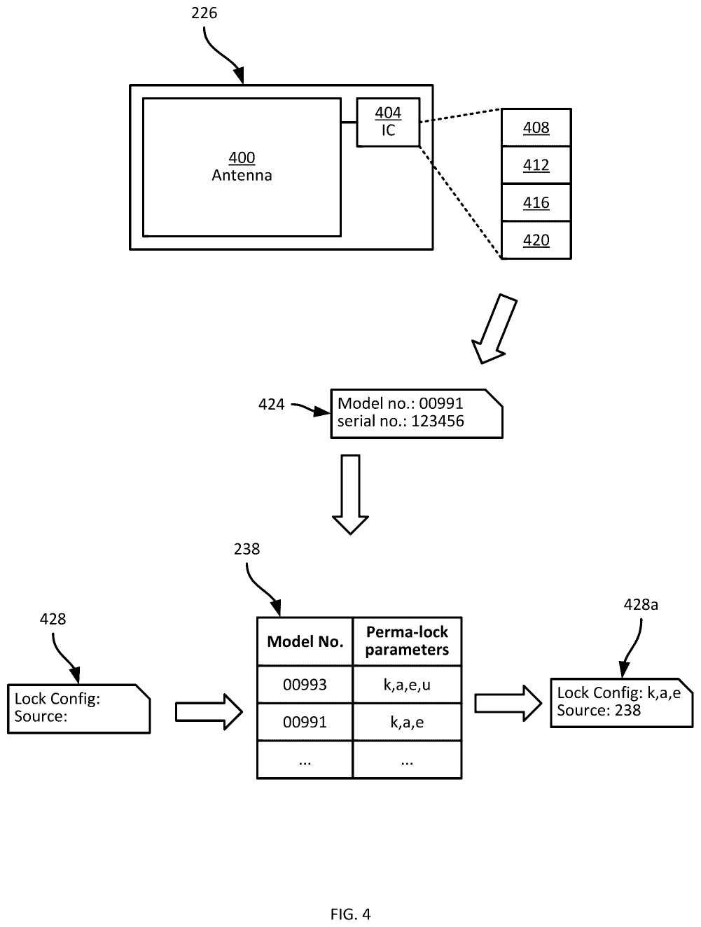

When the determination at block 310 is negative, the device 100 is configured to obtain a set of parameters corresponding to the RF tag 226, for use in generating a perma-lock command. The device 100 is configured, at block 312, to read one or more tag attributes. For example, the device 100 can be configured to read TID data from a TID memory bank of the RF tag 226. Turning to FIG. 4, example components of the RF tag 226 are shown. The RF tag 226 includes an antenna 400, e.g., a coil of wire, circuit trace, or the like, as well as an integrated circuit 404 that includes one or more memory banks. The memory of the IC 404 can include, as shown in FIG. 4, a TID bank 408 containing the TID data mentioned above. The memory can also include an EPC bank 412, e.g., configured to be written by the RF transcoder 224. The EPC bank 412 may also be referred to as the writable storage of the RF tag 226, in that the EPC bank 412 may be the primary target for data written by the device 100. The memory can also include a reserved bank 416, e.g., storing access data (e.g., a “kill” password used to deactivate the RF tag 226, and an access password used to unlock the RF tag 226) used to deactivate the tag 226, or to lock or unlock the EPC bank or other portions of the memory (though not necessarily the TID bank 408, which may be permanently locked as noted above).

The memory can also include, in some RF tags 226, an auxiliary writable bank 420 that may be referred to as a “user” bank. The auxiliary bank 420 may have a smaller writable capacity than the EPC bank, and may be used for certain application-specific data. Some RF tags 226 lack auxiliary banks 420.

Referring again to FIG. 3, at block 312, the device 100 can be configured to read TID data 424 from the TID bank 408, such as a tag serial number “123456” and model number “00991” as shown in FIG. 4. Referring again to FIG. 3, at block 315 the device 100 can be configured to determine whether the repository 238 contains lock configuration data corresponding to the RF tag 226, e.g., by looking up the model number in the repository 238. When the determination at block 315 is affirmative, as is the case in FIG. 4, the device 100 proceeds to block 320. At block 320, the device 100 sets the current lock configuration data according to the stored configuration retrieved from the repository 238.

As shown in FIG. 4, the model number “00991” appears in the repository. The device 100 is therefore configured, at block 320, to retrieve the set of parameters “k,a,e”, and update current lock configuration data 428 (which was previously blank or not populated) to current lock configuration data 428a, to contain the set of parameters from the repository 238. A wide variety of parameters can be implemented. The example parameters shown in FIG. 4 include “k”, corresponding to a portion of the bank 416 containing a kill password, “a,” corresponding to a portion of the bank 416 containing an access password, “e,” corresponding to the EPC bank 412, and “u,” corresponding to the auxiliary bank 420. Other parameters can also be used, e.g., including a parameter “t,”corresponding to the TID bank 408.

The device 100 can also include, e.g., in the lock configuration data 428a, an indication of the source of the active parameters (e.g., the repository 238 in this example). Returning to FIG. 3, after setting the lock configuration data 428a at block 320, the device 100 is configured to proceed to execute the command from block 305, as will be discussed further below.

When the determination at block 315 is negative, the device 100 is configured to proceed to block 325. In the absence of pre-configured lock configuration data, the device 100 is configured to attempt to infer lock configuration data for the RF tag 226 (which can then be maintained and used for any further RF tags 226 until the media supply 204 is replaced). At block 325, the device 100 is configured to determine whether the RF tag 226 includes an auxiliary memory bank 420. The device 100 can, for example, attempt to read the auxiliary memory bank 420, and if the read operation fails, the determination at block 325 is negative.

When the determination at block 325 is affirmative, the device 100 is configured, at block 330, to set the current lock configuration 428 to contain a first predefined set of parameters, e.g., contained within the application 236 or otherwise stored separately from the repository 238. The device 100 can, for example, be configured to set the lock configuration data 428 to include the parameters “k,a,e,u”, including the parameter “u”, as the RF tag 226 includes a user bank 420.

When the determination at block 325 is negative, the device 100 is configured, at block 330, to set the current lock configuration 428 to contain a second predefined set of parameters. For example, the device 100 cam be configured to set the lock configuration data 428 to include the parameters “k,a,e,” omitting the parameter “u”, as the RF tag 226 does not include a user bank 420.

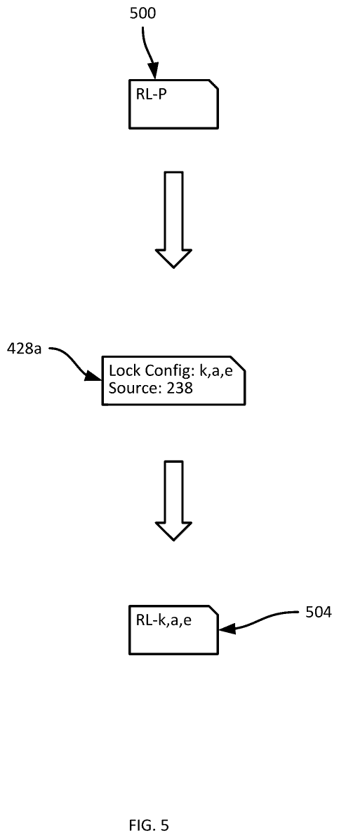

Following the performance of block 330 or 335, or a performance of block 320 as mentioned earlier, the device 100 is configured to proceed to block 340. At block 340, the device 100 is configured to generate and execute a new command based on the command from block 305, and the lock configuration data set via blocks 320, 330, or 335. As will be apparent, in some instances the command from block 305 is a read command or the like, and the device 100 can execute the command as-is. When the command from block 305 is a lock command, or includes a lock command, however, the device 100 is configured to generate a new corresponding lock command that is specific to the RF tag 226 (e.g., to the type of the RF tag 226), based on receipt of the lock command and based on the lock configuration data 428. For example, as shown in FIG. 5, the command from block 305 can include a command 500 containing a generic or universal perma-lock command “RL-P”. For example, the parameter “P” may indicate that the command 500 is intended to permanently lock the RF tag 226. The command 500 does not, however, identify any specific memory banks of the RF tag 226 to be locked by the command. Thus, the operator of the device 100 is not required to specify or have any knowledge about the individual memory banks of the RF tag to be permanently locked.

The device 100 is configured, at block 340, to generate a new perma-lock command 504 in response to the generic or universal perma-lock command by inserting the set of parameters from the lock configuration data 428a mentioned earlier. The device 100 can then execute the perma-lock command 504 relative to the RF tag 226. Thus, the device 100 can generate a specific perma-lock command including the parameters for locking the memory banks for a particular RF tag where the generated specific new perma-lock command that is generated in response to the general or universal perma-lock command based on the device identifying the media installed in the device and the type or model of RF tags included in the media.

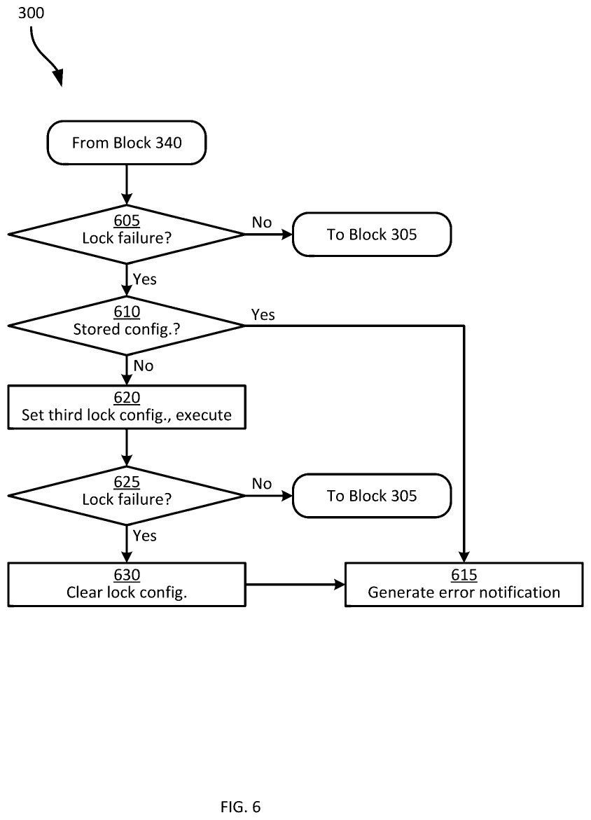

When the command from block 305 is a perma-lock command, and when executing the command at block 340 therefore includes initiating a lock operation, the device 100 can then assess whether the lock operation succeeded, as shown in FIG. 6, which illustrates a continuation of the method 300. At block 600, the device 100 determines whether the lock operation initiated at block 340 failed, e.g., based on return signals from the RF tag 226 in response to the lock operation. If the determination at block 605 is negative, performance of the method 300 can terminate, and the device 100 can return to block 305 to await a further command (e.g., for the next RF tag 226).

When the determination at block 605 is affirmative, the device 100 can proceed to block 610. At block 610, the device 100 is configured to determine whether the source of the parameters stored in the current lock configuration data 428 is the repository 238. When the determination at block 610 is affirmative, the device 100 can be configured to generate an error notification at block 615, e.g., via the communications interface 240, a local output device (e.g., an indicator light), or the like. An affirmative determination at block 610 indicates that the lock operation failed despite the parameters used in the lock operation being present in the repository 238, which may indicate physical damage to the RF tag 226 or an issue other than incorrect lock parameters.

When the determination at block 610 is negative, e.g., when the source of the current lock configuration data 428 is the first or second sets of parameters noted above as used at blocks 330 and 335, the device 100 is configured to proceed to block 620. At block 620, the device 100 is configured to set the current lock configuration data 428 to a third set of parameters. For example, the third set of parameters can introduce a parameter identifying the TID bank 408. Although many or all RF tags 226 may include a TID bank 408, some RF tags 226 may not support a lock parameter explicitly identifying the TID bank 408. Thus, when the first or second parameter sets from blocks 330 or 335 fail, the reason for the failure may be that the RF tag 226 is of a type that does support explicit identification of the TID bank 408. The third set of parameters can include, for example, the parameters “k,a,e,u,t”. In other examples, the third set of parameters can depend on whether the first or second set were used at block 330 or block 335. For example, the “source” attribute of the current lock configuration data 428 can indicate which of the first and second sets were selected. Thus, following a performance of block 335, the third set can append the parameter “t”, resulting in the parameters “k,a,e,u,t”. Following a performance of block 330, however, and appending the parameter “t” at block 620, the third set of parameters may be “k,a,e,t”.

The device 100 is further configured to repeat the lock operation at block 620, with the third set of parameters as set out above. The device 100 is configured to determine whether the repeated lock operation succeeded at block 625. When the determination at block 625 is negative, the device 100 can return to block 305 to await a further command. When the determination at block 625 is affirmative, at block 630 the device 100 can clear the lock configuration data 428, and generate an error notification at block 615. Arriving at block 630 indicates that the RF tag 226 is not represented in the repository 238, and that attempts to infer lock parameters for the RF tag 226 have failed.

In some examples, e.g., in response to detecting successful perma-locking at block 605 or at block 625, the device 100 can generate a notification (e.g., to the host computing device via the interface 240) recommending that an operator of the device 100 obtain an updated repository 238, and/or make an update to the repository 238 with the lock parameters that successfully locked the RF tag 226.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method in a media processing device, the method comprising:
obtaining a set of parameters corresponding to a radiofrequency (RF) tag associated with a media supply;
receiving a first command to lock the radiofrequency (RF) tag;
generating a second command in response to receipt of the first command, the second command replacing the first command and including the set of parameters; and
initiating an operation to lock the RF tag based on the second command.

2. The method of claim 1, wherein the first command is generic to a plurality of types of RF tag.

3. The method of claim 1, wherein the parameters in the set of parameters correspond to respective memory banks of the RF tag.

4. The method of claim 1, wherein obtaining the set of parameters includes:
storing a repository of parameter sets corresponding to respective types of RF tag at the media processing device;
determining a type of the RF tag; and
obtaining the set of parameters based on the determined type.

5. The method of claim 4, wherein determining the type of the RF tag includes reading an identifier from the RF tag.

6. The method of claim 4, wherein obtaining the set of parameters based on the determined type includes retrieving the set of parameters from the repository.

7. The method of claim 4, wherein obtaining the set of parameters based on the determined type includes:
determining that the repository does not contain a set of parameters corresponding to the determined type; and
selecting a predefined set of parameters.

8. The method of claim 7, wherein selecting the predefined set of parameters includes:
reading an auxiliary memory bank of the RF tag; and
when the reading succeeds, selecting a first set of parameters including an auxiliary bank lock parameter; and
when the reading fails, selecting a second set of parameters omitting the auxiliary bank lock parameter.

9. The method of claim 8, further comprising:
when the lock operation fails, selecting a third set of parameters including a tag identifier (TID) bank lock parameter; and
repeating the lock operation.

10. A device, comprising:
a housing;
a printhead disposed in the housing, the printhead being configured to print on a media supply;
a radiofrequency (RF) transcoder disposed in the housing; and
a controller configured to:
obtain a set of parameters corresponding to a radiofrequency (RF) tag associated with a media supply;
receive a first command to lock the radiofrequency (RF) tag;
generate a second command in response to the first command, the second command replacing the first command and including the set of parameters; and
initiate an operation to lock the RF tag based on the second command.

11. The device of claim 10, wherein the first command is generic to a plurality of types of RF tag.

12. The device of claim 10, wherein the parameters in the set of parameters correspond to respective memory banks of the RF tag.

13. The device of claim 10, wherein the controller is configured to obtain the set of parameters by:
storing a repository of parameter sets corresponding to respective types of RF tag at the media processing device;
determining a type of the RF tag; and
obtaining the set of parameters based on the determined type.

14. The device of claim 13, wherein the controller is configured to determine the type of the RF tag by reading an identifier from the RF tag.

15. The device of claim 13, wherein the controller is configured to obtain the set of parameters based on the determined type by retrieving the set of parameters from the repository.

16. The device of claim 13, wherein the controller is configured to obtain the set of parameters based on the determined type by:
determining that the repository does not contain a set of parameters corresponding to the determined type; and
selecting a predefined set of parameters.

17. The device of claim 16, wherein the controller is configured to select the predefined set of parameters by:
reading an auxiliary memory bank of the RF tag; and
when the reading succeeds, selecting a first set of parameters including an auxiliary bank lock parameter; and
when the reading fails, selecting a second set of parameters omitting the auxiliary bank lock parameter.

18. The device of claim 17, wherein the controller is further configured to:
when the lock operation fails, select a third set of parameters including a tag identifier (TID) bank lock parameter; and
repeat the lock operation.
